(19) United States
(12) Patent Application Publication
(10) Pub. No.: US 2010/0108474 A1
(43) Pub. Date: May 6, 2010

(54) CONVEYOR SYSTEM

(76) Inventors: Darrell Knigge, Wetmore, CO (US); Thomas Harding, Canon City, CO (US); Patrick Morrow, Colorado Springs, CO (US); David Krenz, Pueblo, CO (US); Martin Telck, Canon City, CO (US)

Correspondence Address: KLAAS, LAW, O''MEARA & MALKIN, P.C., 1999 BROADWAY, SUITE 2225, DENVER, CO, 80202, US

(21) Appl. No.: 12/688,730

(22) Filed: Jan. 15, 2010

Related U.S. Application Data
(63) Continuation of application No. 12/349,443, filed on Jan. 6, 2009.
(60) Provisional application No. 61/081,117, filed on Jul. 16, 2008.

(51) Int. Cl. B65G 23/18

(52) U.S. Cl. 198/805

(57) ABSTRACT

A conveyor system is disclosed herein. An embodiment of the conveyor system comprises a first end, a second end, a first side, and a second side. A belt extends between the first end and the second end. The belt has a belt first side located proximate the first side of the conveyor. A first magnetic force acts on the belt first side relative to the first side of the conveyor.

This application is continuation in part of U.S. application Ser. No. 12/349,443 filed on Jan. 6, 2009, which is a continuation of and claims priority to U.S. provisional application 61/081,117 filed on Jul. 16, 2008, which are both hereby incorporated by reference for all that is disclosed therein.

### BACKGROUND

Belt conveyor systems use belts to convey items. Conventional belt conveyor systems use rollers, guides, and other mechanisms to orient the belt or to maintain tension on the belt. For example in a curved conveyor system, guides, rollers, and other mechanisms are used to maintain tension on the belt. Without the tension, the belt will become unstable, which will cause the conveyor to fail.

The aforementioned rollers, guides, and other mechanisms used to orient the belt generate a great amount of friction. This friction increases the power required to operate the conveyor in addition to the amount of noise generated by the conveyor. The mechanisms also limit the speed at which the conveyors, especially curved conveyors, can operate.

### BRIEF DESCRIPTION OF THE DRAWINGS

FIG. 1 is a top view of an embodiment of a conveyor system.

FIG. 2 is a perspective view of the first end of the conveyor system of FIG. 1 showing some of the internal components of the conveyor system.

FIG. 3 is a top view of the conveyor system of FIG. 1 with the belt removed.

FIG. 4 is an exploded view of an embodiment of a portion of a chain used in the conveyor system of FIG. 3.

FIG. 5 is a bottom view of an embodiment of the conveyor system of FIG. 1.

FIG. 6 is a side cutaway of another embodiment of a portion of the conveyor system of FIG. 1.

FIG. 7 is a side cut away view of an embodiment of the return path of the conveyor of FIG. 1.

FIG. 8 is a top view of an embodiment of a chain retainer.

FIG. 9 is a side view of the chain retainer of FIG. 8.

FIG. 10 is a side cut away view of an embodiment of a conveyor.

FIG. 11 is a top perspective view of an embodiment of a magnet block of the conveyor of FIG. 10.

FIG. 12 is a top plan view of an embodiment of the chain of FIG. 10.

### DETAILED DESCRIPTION

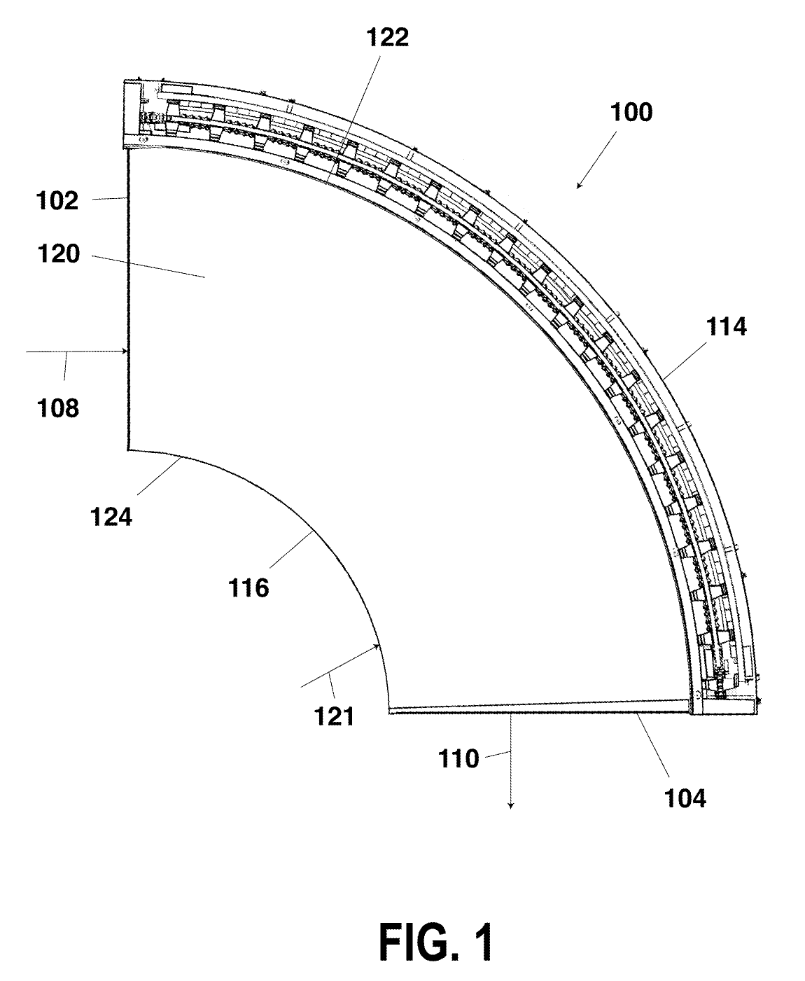

Conveyor systems using magnetic forces to orient a belt and provide tension on a belt are described herein. One embodiment of such a conveyor system is shown in FIG. 1, which is a top plan view of a belt-type conveyor system 100 (sometimes simply referred to as a conveyor 100). The conveyor system 100 is a horizontal, curved conveyor. However, the conveyor 100 may be virtually any other type of conveyor, such as a straight conveyor, a conveyor that is not horizontal, a spiral type conveyor, or a conveyor that turns 180 degrees.

The conveyor 100 has a first end 102 and a second end 104, wherein items are conveyed between the first end 102 and the second end 104. Because the conveyor 100 of FIG. 1 is curved, items may enter the first end 102 traveling in a first direction 108 and exit the second end 104 traveling in a second direction 110. The angle between the first direction 108 and the second direction 110 may be virtually any angle. In a straight conveyor, the first direction 108 is substantially the same as the second direction 110.

The conveyor system 100 has an outer frame 114, sometimes referred to as a first member, and an inner frame 116 located opposite the outer frame 114. The outer frame 114 and the inner frame 116 may extend at least partially between the first end 102 and the second end 104 of the conveyor 100. Both the first end 102 and the second end 104 may have pulleys or rollers located therein and are described in greater detail below.

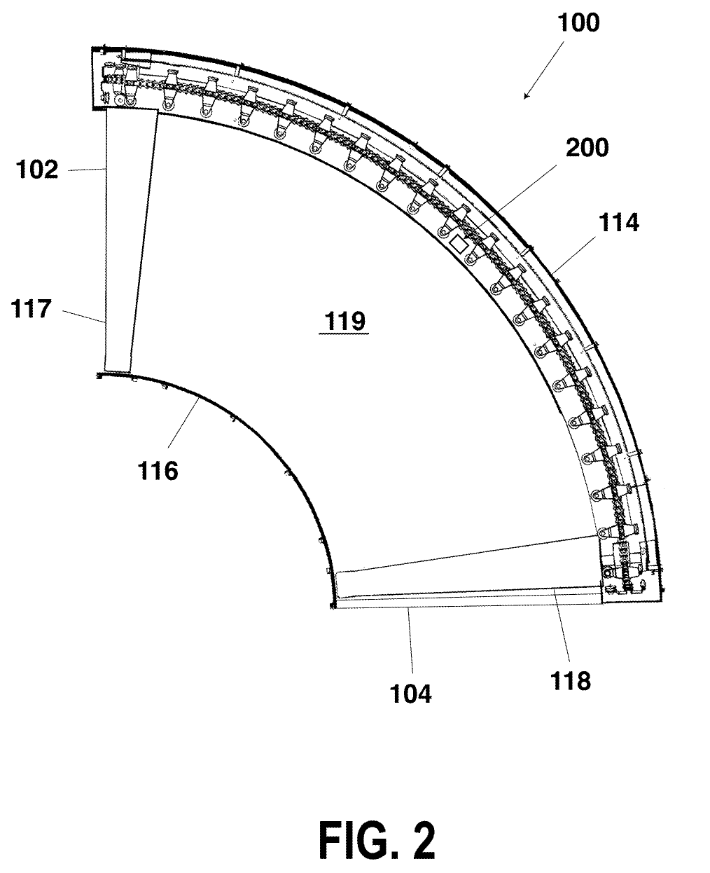

With additional reference to FIG. 2, which is a view of the conveyor system 100 of FIG. 1 with the belt (described below) removed, the conveyor system 100 has two rollers 117, 118. A first roller 117 is located proximate the first end 102 and a second roller 118 is located proximate the second end 104. The rollers 117, 118 may extend substantially between the outer frame 114 and the inner frame 116. Because the conveyor system 100 described herein is curved, the rollers 117, 118 are tapered in order to accommodate a conical-shaped belt. In some embodiments, pulleys may be used in place of at least one of the rollers 117, 118. A platform 119 extends between the first roller 117 and the second roller 118 and is used to support the belt as described below. It is noted that other support mechanisms, such as rollers and the like, may be used to support the belt. In some embodiments, the platform 119 rolled or formed in the shape of a roller, thus, alleviating the need for the rollers 117, 118.

A continuous belt 120 extends and travels between the first end 102 and the second end 104. More specifically, the belt 120 passes over the aforementioned rollers 117, 118. The belt 120 has a first side 122 and a second side 124, which is opposite the first side 122. The first side 122 is located proximate the outer radius of the conveyor curve and the second side 122 is located proximate the inner radius of the conveyor curve. As described above, the belt 120 sets and slides on the platform 119. The belt material and platform material may be chosen to have a low coefficient of friction.

Due to the nature of curved conveyors, the tension of the belt 120 must be maintained on the rollers 117, 118, otherwise, the belt 120 will slip off the rollers 117, 118. More specifically, a force in the direction 121 along the radius of the curved conveyor 100 must be maintained. The conveyor 100 described herein uses magnetic forces to maintain the belt first side 122 proximate the outer frame 114, which serves to maintain belt tension on the rollers 117, 118.

Conventional conveyors, including curved conveyors, are limited in the speed at which the belt can travel because they use rollers and/or guides, and other mechanisms, to maintain the belt first side proximate the outer frame. These rollers, guides, and other mechanisms have friction, which limits the speed at which the belt can travel. The friction also causes the belt to become unstable at high speeds. In addition, the friction requires a great amount of power to move the belt. The friction also generates substantial noise when the conveyor operates. As described in greater detail below, the conveyor 100 described herein overcomes these problems by replacing the rollers, guides, and other mechanisms with magnets and/or magnetic forces. Therefore, frictionless magnetic forces are used to maintain the belt first end 122 proximate the outer frame 114.

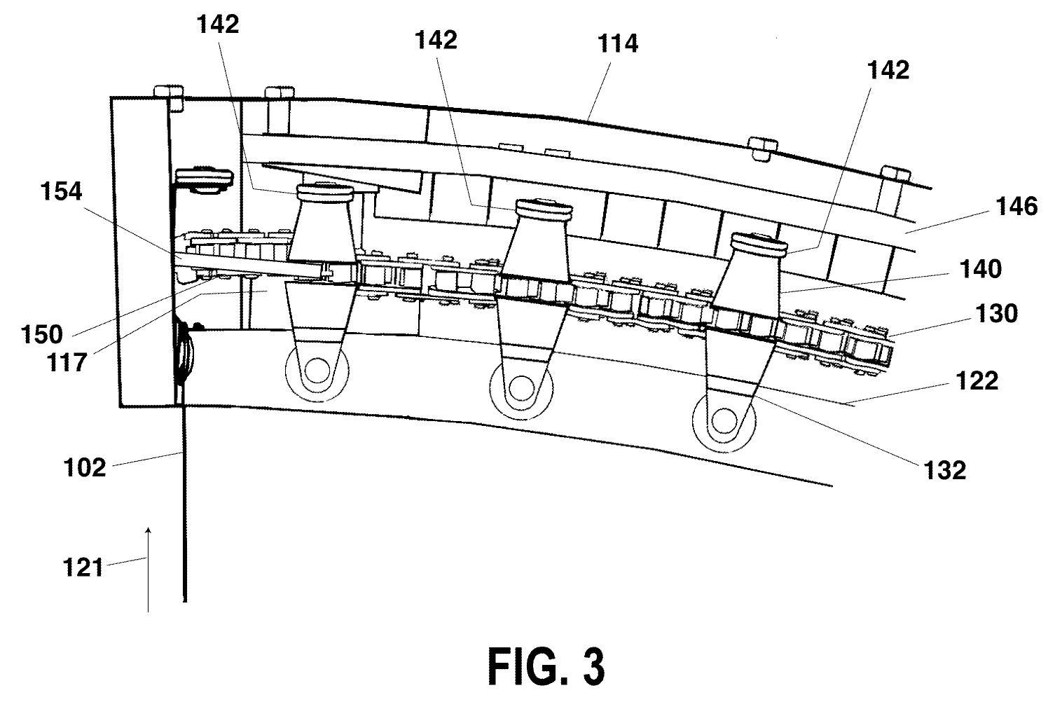

An exploded view of the first end 102 of the conveyor 100 is shown in FIG. 3. The view of FIG. 3 has covers removed so that the components within the conveyor 100 are visible. The conveyor 100 includes a movement mechanism, which in the embodiment of FIG. 3 is a chain 130. The chain 130 is connected to the belt 120 by way of a plurality of first connectors 132. The chain 130 is also connected to a plurality of magnets 142 by way of a plurality of second connectors 140.

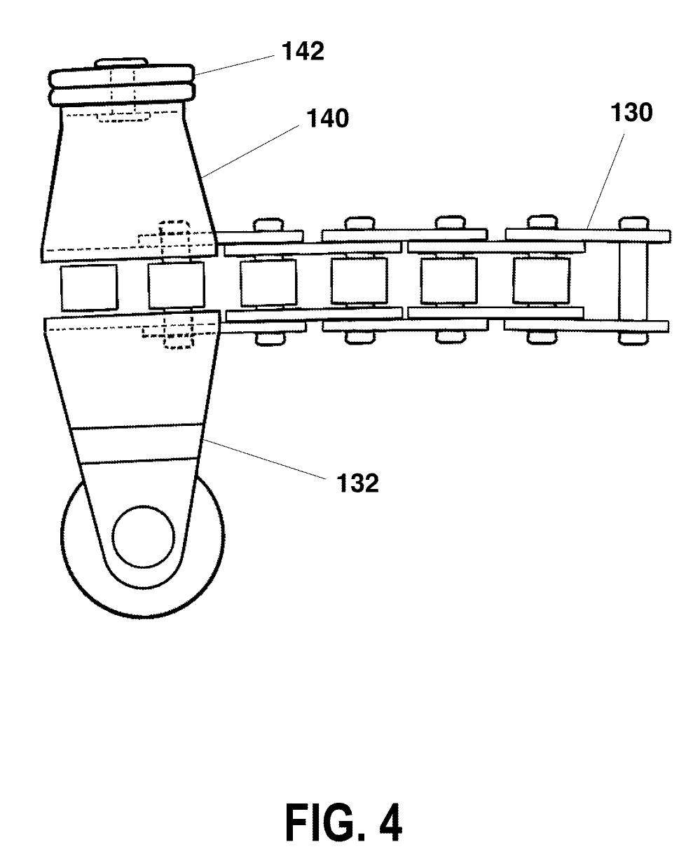

An exploded view of an embodiment of the chain 130 is provided in FIG. 4. As shown in FIG. 4, the first connectors 132 and the second connectors 140 may be links within the chain 130. It is noted that in some embodiments, the second connectors 140 may be connected to magnetic materials or magnets. In some embodiments, the first connectors 132 and the second connectors 140 may be a single unit attached to the chain 130. It is noted that drive mechanisms other than the chain 130 may be used within the conveyor 100. For example, the chain 130 may be replaced by a cable.

Referring again to FIG. 3, located proximate the magnets 142 is a first rail 146. The first rail 146 may be fixed relative to the outer frame 114. In some embodiments, the first rail 146 is comprised of magnetic material. In some embodiments, the first rail 146 comprises a plurality of magnets. Regardless of the magnet configuration, magnetic force attracts the second connectors 140 to the first rail 146. Accordingly, a force is applied on the belt 120 in the direction 121 by the magnetic forces. In some embodiments, the magnets 142 are configured so that a first polarity faces the first rail 146. The first rail 146 is magnetized or has magnets located therein so that the polarity opposite the first polarity faces the magnets 142.

The rail 146 is shown as being offset or spaced from the outer frame 114. This spacing prevents magnetic material, such as steel, within the conveyor 100 from acting upon or adversely affecting the above-described magnetic forces. In some embodiments, the rail 146 may be attached to the outer frame 114. In other embodiments, a nonmagnetic material, such as aluminum or stainless steel, may be placed between the rail 146 and the outer frame 114.

A drive mechanism, such as a motor moves the chain 130, which moves the belt 120. In addition, the chain 130 may be connected to the rollers 117, 118, FIG. 2. In these embodiments, the first roller 117 may be attached to a sprocket 150, which is also connected to the chain 130. Thus, as the chain 130 moves, the first roller 117 also moves. In other embodiments, the first roller 117 is not connected to the sprocket 150 and the first roller 117 moves by way of movement of the belt 120. The sprocket 150 may then serve to guide the chain 130 and may also be connected to the drive mechanism so as to drive the chain 130.

The magnetic forces described above maintain the first belt end 122 proximate the outer frame 114 without the use of rollers, guides, or other devices, which significantly reduces friction and the above-described problems associated with friction. Therefore, as the belt 120 moves, the belt first end 122 is forced toward the outer frame 114 by the magnetic forces. This situation enables the belt first end 122 to remain taunt without friction generating devices. It is noted that the magnetic forces also support the belt first end 122 in the vertical direction so sagging of the belt first end 122 is minimized. Supporting the belt 120 in the vertical direction may be accomplished by selecting the magnets 142 and the rail 146. For example, if the magnets 142 have substantially the same height as the rail 146, the vertical position of the belt 120 is better maintained.

In some embodiments, a chain rail 154 may be provided.

The chain rail 154 may extend the length of the conveyor system 100 and serves to keep the chain 130 from oscillating or becoming unstable. The chain rail 154 may slightly contact the chain 130 and may be made of a material that has very low friction relative to the chain 130. In some embodiments, the chain 130 rolls on the chain rail 154.

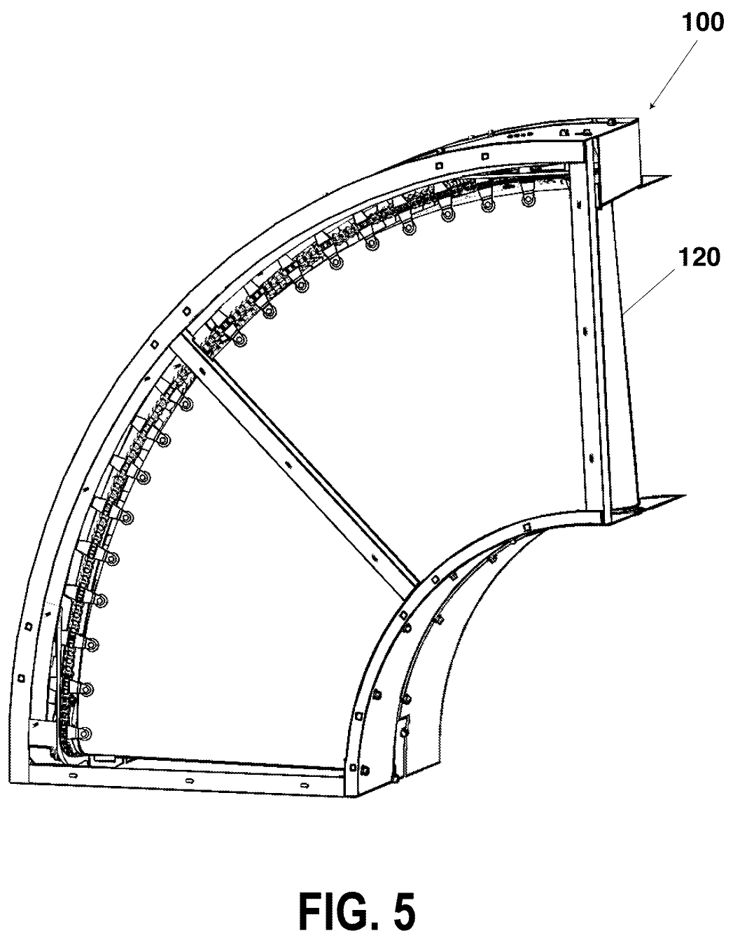

Having described the top portion of the conveyor 100, the bottom portion will now be described. When the belt 120 is described in the lower section of the conveyor 100, it is referred to as being in the return path. Accordingly, the return path refers to the path of the belt 120 when it is not conveying items. In some embodiments, the magnet and rail system described above may be used to support the belt 120 in the return path. Because the return path does not necessarily have a platform to support the belt 120, rollers or pulleys (not shown in FIG. 5) may be provided to support the belt. The rollers or pulleys may extend between the outer frame 114 and the inner frame 116. The number and type of rollers is a design consideration and may depend on the type of belt, the length of the conveyor, the speed of the belt, and other considerations. Other embodiments of the return path will be described below.

Having described some embodiments of the conveyor system 100, its operation will now be described. Other embodiments of the conveyor system 100 will be described further below. Referring to FIGS. 1-3, the belt 120 is maintained in position by the magnetic forces exerting a force on the belt 120 in the direction 121. The force of the belt 120 is applied to the tapered rollers 117, 118. Therefore, the belt 120 is kept in constant tension by the magnetic forces. The amount of tension may be controlled by the flux of the magnets used therein and the distance between the second connectors 140 and the first rail 146.

A drive mechanism moves the chain 130, which is connected to the belt 120 via the first connectors 132. Thus, the belt 120 moves as the chain 130 moves. As the belt 120 moves, it slides on the platform 119 and rolls on the rollers 117, 118. In the return path, the belt 120 may be supported by rollers as described above. Therefore, during operation, the only friction in the conveyor 100 is in the drive mechanism, the rollers 117, 118, and between the platform 119, and the belt 120. Therefore, the power required to operate the conveyor 100 is much less than the power required to operate a conventional conveyor. In addition, the noise of the conveyor 100 is much less than the noise of a conventional conveyor. The use of the magnetic forces to maintain the belt 120 in tension stabilizes the belt 120 relative to conventional conveyors. Therefore, the belt 120 is able to operate at higher speeds than belts used in conventional conveyors.

Some embodiments of the conveyor of FIGS. 1-3 will now be described. Different magnetic configurations between the first rail 146 and the second connectors 140 may be used. For purposes of this specification, the term magnetic material is a material, such as iron or steel, that is attracted to a magnet or acts under a magnetic force. The embodiments described above have magnets attached to the second connectors 140 and the first rail 146 is magnetic or has magnets located therein. In another embodiment, the first rail may be comprised of a magnetic material such that the magnets 142 attached to the second connectors 140 are attracted to the first rail 146. In another embodiment, the first rail is magnetic, the second connectors 140 comprise magnetic material, and the magnets 142 are not used. In this embodiment, the magnetic first rail 146 attracts the second connectors 140. In some embodiments, the chain 130 is made of a magnetic material, which increases the magnetic attraction to the first rail 146.

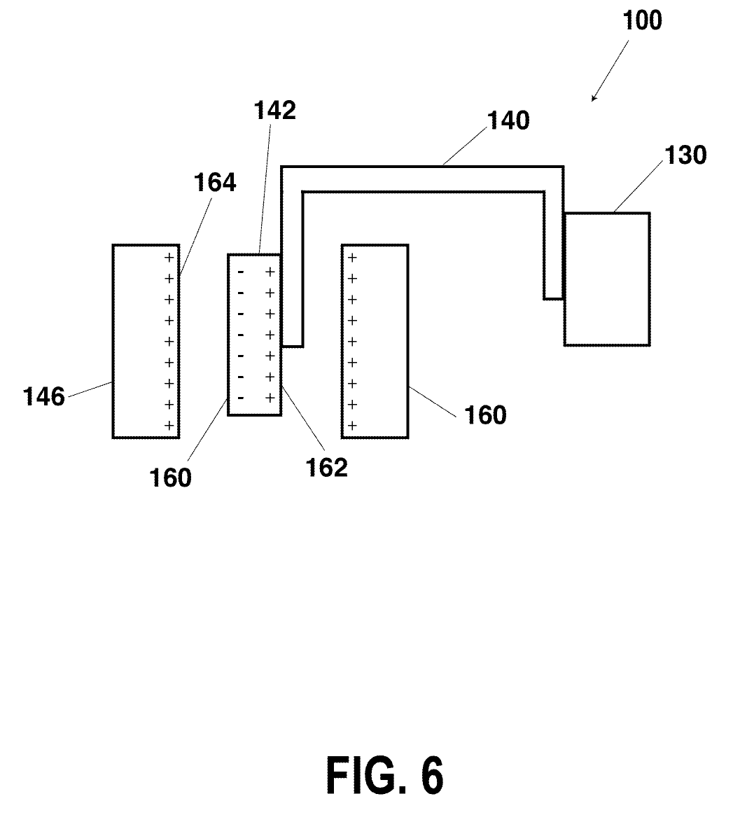

A side cutaway view of another embodiment of the conveyor 100 is shown in FIG. 6. In this embodiment, two magnetic rails 146, 160 are provided in order to increase the magnetic force applied to the second connectors 140. The second connectors 140, the magnets 142, and the first rail 146 may be the same as described above. However, the second connectors 140 may be made of a nonmagnetic material, such as stainless steal. The magnets 142 have a first face 160 having a first polarity and an opposite face 162 having the opposite polarity. The first rail 146 has a face 164 that is polarized opposite the polarity of the first face 160 of the magnets 142. Thus, there is magnetic attraction between the magnets 142 and the first rail 146. Additional magnetic force is generated by the second rail 160. The second rail 160 has a face that is magnetized, or has magnets located therein, with a polarity that is the same as the polarity of the second face of the magnets 142. Therefore, the second rail increases the magnetic force applied to the connectors 140 via a magnetic repulsion force.

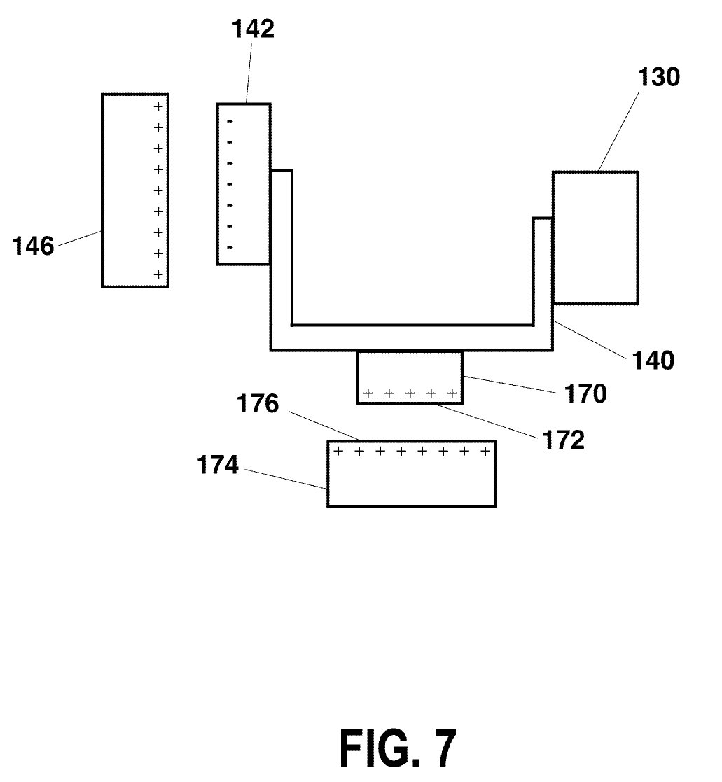

An alternate version of the return path is shown in FIG. 7, which is a partial cutaway view of the association between the second connectors 140 and the rail 146. In this embodiment, a second magnet 170 is mounted to the first connector. The second magnet 170 has a face 172 that is polarized. A third rail 174 is provided proximate the second magnet 170. The third rail 174 has a face 176 that is magnetized with the same polarity as the face 172 of the second magnet 170. The configuration of the second magnet 170 and the third rail 174 serves to repel the second connector 140, which supports the belt 120 in the vertical direction in the return path.

The conveyor 100 has been described as a curved conveyor. However, it is possible to use the magnetic forces in a straight conveyor. In a straight conveyor, forces are not required to pull on the sides of the belt as this tension is not as critical. Therefore, magnetic configurations as shown in FIG. 6 may be employed with both rails 146, 160 repelling the magnets 142. Accordingly, the face 164 of the first rail 146 may be polarized so as to be the same as the first face 160 of the magnets 142. Such a configuration will orient the belt in a straight conveyor. In a similar embodiment, both sides of the belt and conveyor may have magnetic configurations as described above.

Some uses of the conveyor 100 may cause the belt 120 (FIG. 2) to move slightly in a direction opposite the direction 121. For example, if a heavy load is suddenly placed on the belt 120, the belt may move slightly in the direction opposite the direction 121. Because magnetic force is exponentially proportional to distance, this slight shift of the belt may cause the magnets 142 to be out of the effective range of the first rail 146. In order to overcome this issue, the conveyor 100 may have a chain retainer 200 or a plurality of chain retainers 200 located therein. In summary, the chain retainer 200 prevents the chain 130, and thus, the magnets 142 from moving too far from the first rail 146. Therefore, the magnets 142 are always maintained within an effective distance of the first rail 146.

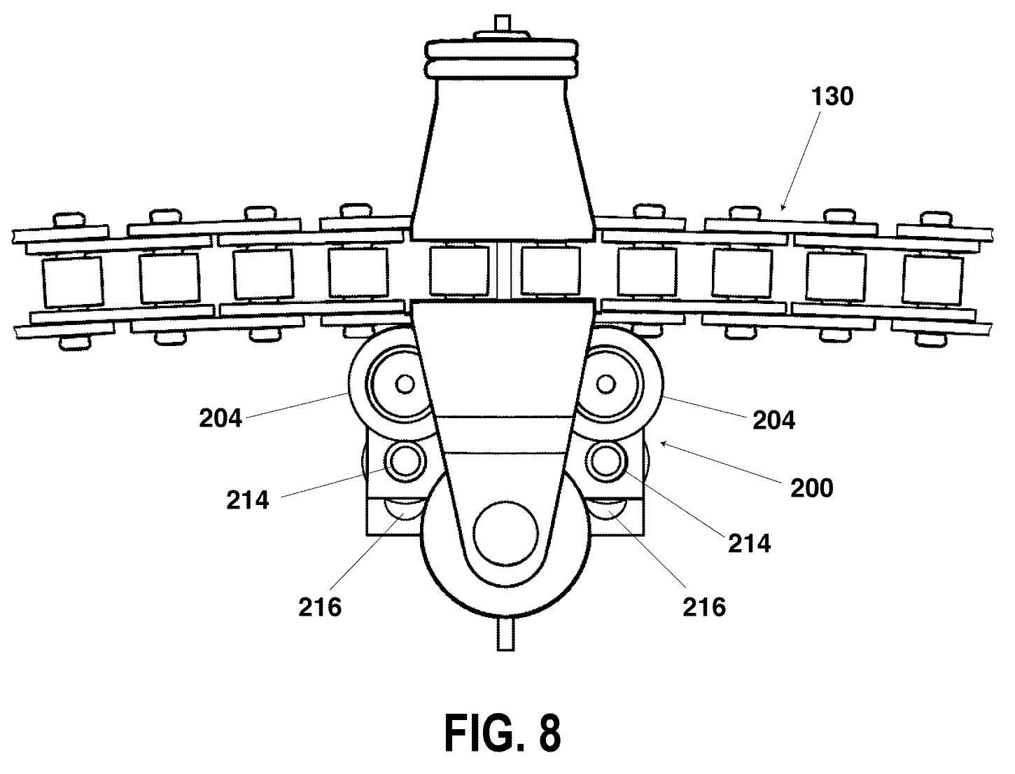

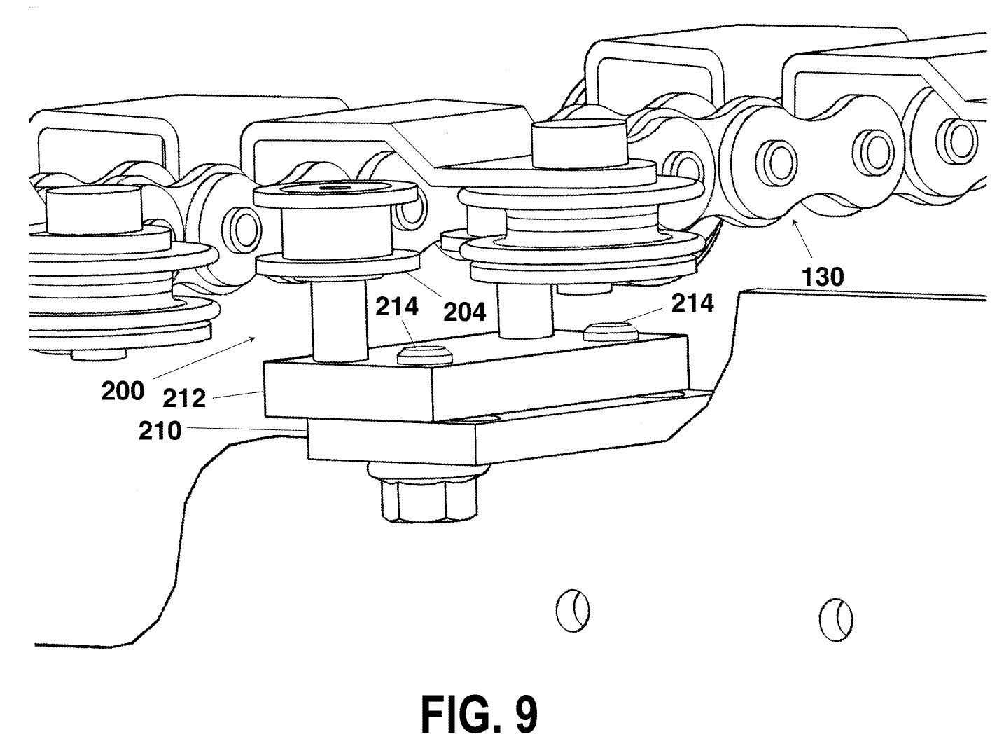

A top view of an embodiment of the chain retainer 200 is shown in FIG. 8 and a side view of the chain retainer 200 is shown in FIG. 9. The chain retainer 200 is fixed to a chassis member or other non-movable device within the conveyor 100. The chain retainer has at least one roller 204 that is able to contact the chain 130. The embodiment of the chain retainer 200 described herein has two rollers 204. The rollers 204 may contact the chain 130 during operation or when the belt 120 moves as described above. The use of the rollers 204 adds very little friction and noise to the conveyor 100, so the use of the chain retainer 200 has very little impact on the operation of the conveyor 100. In some embodiments, low friction elements, such as plastic or nylon type devices are used in place of the rollers 204.

The chain retainer 200 has a first plate 210 that mounts to a chassis as described above. A second plate 212 is movably attached to the first plate 210. Retainers 214 are movable in slots 216, which allow the second plate 212 to move relative to the first plate 210. The movement enables the chain retainer 200 to maintain the position of the chain at very precise points.

The number of chain retainers 200 used in a conveyor depends on the radius of the conveyor, the shape of the conveyor and the loads placed on the conveyor. For example, a u-shaped conveyor transporting heavy loads may need three. A ninety degree turn conveyor may only need one. A straight conveyor may not need any.

It is noted that devices other than chains may move the belt 120. Accordingly, the above-described chain retainer 200 may serve to act on these other devices in a substantially similar manner as the chain 130.

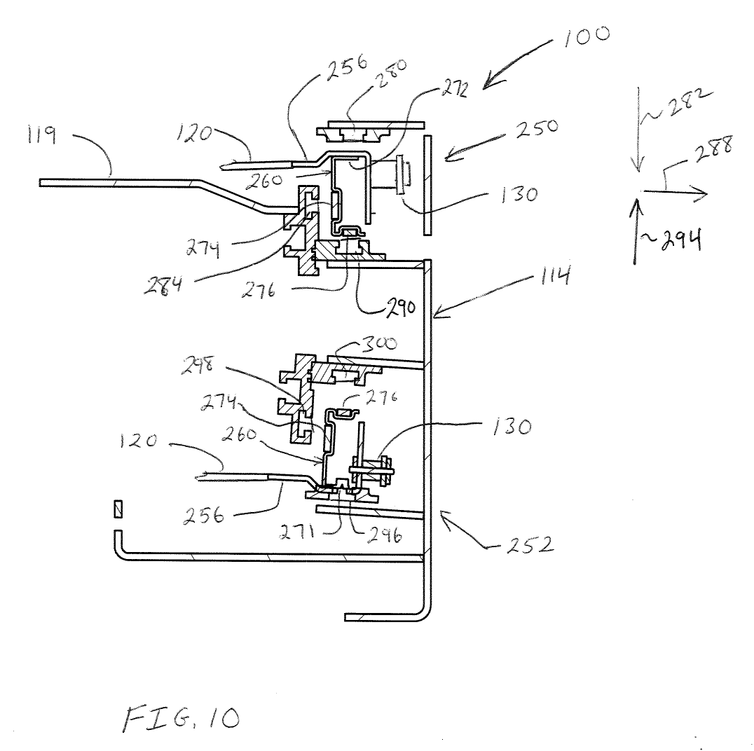

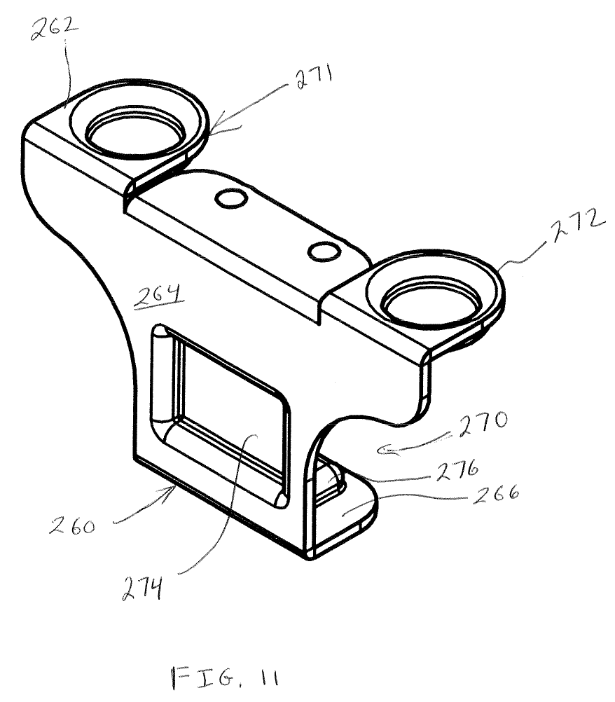

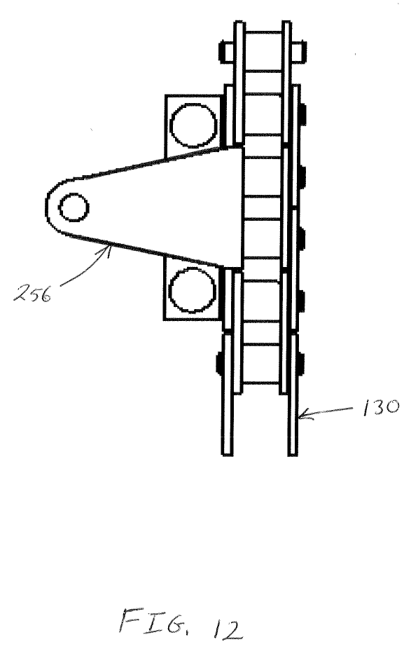

Other embodiments of the conveyor 100 is shown in FIG. 10, FIG. 11, and FIG. 12. FIG. 10 is a side cut away view of an embodiment of the conveyor 100 using a repelling magnet configuration. For reference purposes, the conveyor 100 has an upper portion 250 and a lower portion 252. The upper portion 250 is used by the conveyor to move items via the belt 120. The lower portion 252 is a return path for the belt 120.

In the embodiments of FIGS. 10-12, the belt 120 may be attached to the chain 130 by way of a plurality of connectors 256. A top view of the chain 130 and a connector 256 is shown in FIG. 12. Magnet blocks 260 are connected to the connectors 256. A side perspective view of a magnet block 260 is shown in FIG. 11. The magnet block 260 has a plurality of planes or surfaces with at least one magnet attached to each plane. In the embodiment of FIGS. 10 and 11, the magnet block 260 has three planes, a first plane 262, a second plane 264, and a third plane 266. The first plane 262 may be substantially parallel to the third plane 266 and substantially perpendicular to the second plane 264. The shape of the planes 262, 264, 266 may form a cavity or opening 270.

Each of the planes 262, 264, 266 or surface may have at least one magnet (sometimes referred to as chain magnets) located thereon. In the embodiment of FIG. 11, the first plane 262 has two first magnets 271, 272 located thereon. In some embodiments, the first plane 262 may have a single magnet located thereon. The second plane 264 has a second magnet 274 located thereon. The third plane 266 has a third magnet 276 located thereon. All the magnets 271, 272, 274, 276 may be aligned so as to have the same pole facing the opening 270. For example, all the magnets 271, 272, 274, 276 may have their norths facing the opening 270. It follows that the magnets 271, 272, 274, 276 have the same pole facing opposite the opening 270.

With additional reference to FIG. 10, magnets (sometimes referred to as conveyor magnets) are located in the conveyor 100 so as to repel the magnets 271, 272, 274, 276, which forces the belt 120 toward the outer frame 114. The upper portion 250 has magnets facing the magnet block magnets so as to repel the magnet block magnets. A first magnet 280 (or plurality thereof)+faces the first magnets 271, 272 of the magnet block 260 so as to force the magnet block 260 in a direction 282. A second magnet 284 is located proximate the second magnet 274 of the magnet block 260 and forces the magnet block 260 in a direction 288. A third magnet 290 is located proximate the third magnet 276 on the magnet block 260 and forces the magnet block 260 in a direction 294. The repelling forces between the magnets in the magnet block 260 and the magnets attached to the outer frame 114 force the magnet block, and the belt 120 toward the outer frame 114. The repelling force also causes the chain 130 to float. Accordingly, the chain 130 is able to move without contacting supporting structures. Therefore, it moves with very little friction.

A similar magnetic structure exists in the lower portion 252 of the conveyor 100. A first magnet 296 is located proximate the first magnets 271, 272 of the magnet block 260 and forces the magnet block 260 in the direction 294. A second magnet 298 is located proximate the second magnet 274 on the magnet block 260 and forces the magnet block 260 in the direction 288. A third magnet 300 is located proximate the third magnet 276 on the magnet block 260 and forces the magnet block 276 in the direction 282. Accordingly, the chain 130 on the return path is maintained by the magnetic forces and encounters very little structures. Thus, it moves with little friction.

The upper portion 250 and the lower portion 252 may have a plurality of magnets located therein. For example, the above described magnets may extend the distance or a portion of the distance of the outer frame 114. As shown in FIG. 10, the magnets may be located in slots or other devices (sometimes referred to as members) similar to those described above.

The embodiments of FIG. 10 use a magnetic repulsing force to force the belt 120 toward the outer frame 114. As the belt 114 encounters a load, it will be forced away from the outer frame 114. However, when this happens, the second magnet 274 in the magnet block 260 will move closer to the second magnet 284. Because the repulsive force is inversely proportional to distance, the closer the magnets 274, 284 get to each other, the greater the magnetic force that act to force the belt 120 back toward the outer frame 114.

In some situations, the repulsive force between the magnets 274, 284 will cause the magnetic block to move in the directions 282, 294. If this movement occurs, the magnetic force between the magnets 274, 284 will attenuate significantly. The magnetic forces of the first magnets 271, 272 and the first magnet 380 keep the magnetic block 260 from moving in the direction 294 or keep the magnetic block 260 within boundaries. The repulsive force between the third magnet 276 and the third magnet 290 acts in a similar manner by limiting the movement of the magnet block 260 in the direction 282. Therefore, as the magnet block 260 moves away from the outer frame 114, the second and third magnets maintain its position so that the second magnets 274, 284 can repel each other.

What is claimed is:

1. A conveyor comprising:
a first end;
a second end;
a first side;
a second side;
a belt extending between said first end and said second end, said belt having a belt first side located proximate said first side of said conveyor;
wherein a first magnetic force acts on said belt first side relative to said first side of said conveyor.

2. The conveyor of claim 1, wherein said first magnetic force is a repelling force, wherein said repelling force forces said belt first side toward said first side of said conveyor.

3. The conveyor of claim 1 and further comprising at least one second magnetic force acting on said belt first end, said at least one second magnetic force acts in a direction that is substantially perpendicular to the force of said first magnetic force.

4. The conveyor of claim 3, wherein said second magnetic force is a repelling force.

5. The conveyor of claim 1 and further comprising at least one third magnetic force acting on said belt first end, said at least one third magnetic force acts in a direction that is substantially perpendicular to the force of said first magnetic force.

6. The conveyor of claim 5, wherein said third magnetic force is a repelling force.

7. The conveyor of claim 1 and further comprising at least one second magnetic force acting on said belt first end and at least one third magnetic force acting on said belt first end, said at least one second magnetic force and said at least one third magnetic force acting in a directions that are substantially perpendicular to the force of said first magnetic force; and wherein said at least one second magnetic force and said at least one third magnetic force act in opposite directions, both repelling relative to said belt first end.

8. The conveyor of claim 1, wherein said belt is substantially on a first plane and wherein said first magnetic force acts substantially parallel to said plane.

9. The conveyor of claim 1, wherein said belt first side has a chain attached thereto, said chain having a first chain magnet attached thereto, and wherein said conveyor comprises a first conveyor magnet, said first chain magnet being locatable between said first conveyor magnet and said first side of said conveyor, said first chain magnet and said first chain magnet having the same pole facing each other to create said first magnetic force.

10. The conveyor of claim 9, wherein said chain comprises a second chain magnet and said conveyor comprises a second conveyor magnet, wherein said second conveyor magnet and said second chain magnet face each other with the same pole to create a repelling force, said repelling force being substantially perpendicular to the force between said first conveyor magnet and said first chain magnet.

11. The conveyor of claim 10, wherein said chain further comprises a third chain magnet and said conveyor comprises a third conveyor magnet, wherein said third chain magnet and said third conveyor magnet repel each other in a direction that is substantially perpendicular to the force between said first conveyor magnet and said first chain magnet.

12. A conveyor comprising:
a first end;
a second end;
a first side extending between said first end and said second end;
a second side located opposite said first side;
a first member extending at least partially between said first end and said second end and located proximate said first side, said first member having a first conveyor magnet having a pole facing said first side;
a belt extending and movable between said first end and said second end, said belt having a belt first side located proximate said first member, said belt having a first belt magnet located between said first conveyor magnet and said first side, wherein said first belt magnet pole facing said first conveyor magnet pole is the same as said first magnet pole, creating a repelling force.
a magnetic force between said belt first side and said first member.

13. The conveyor of claim 12, wherein said belt first side has a chain attached thereto, said first chain magnet being attached to said chain.

14. The conveyor of claim 12 and further comprising:
a second conveyor magnet located substantially between said first member and said first side;
a second chain magnet coupled to said chain, said second chain magnet being movable to the proximity of said second conveyor magnet so as to create a repelling magnetic force that is substantially perpendicular to the plane of said belt.

15. The conveyor of claim 14 and further comprising:
a third conveyor magnet located substantially between said first member and said first side;
a third chain magnet coupled to said chain, said third chain magnet being movable to the proximity of said third conveyor magnet so as to create a repelling magnetic force that is substantially perpendicular to the plane of said belt and in an opposite direction of the magnetic force between said second chain magnet and said second conveyor magnet.

16. A method of moving a conveyor belt, said belt being moved relative to a frame, said method comprising:
applying a first magnetic force to said belt, wherein said first magnetic force is a repelling force that forces said belt toward said frame.

17. The method of claim 16 and further comprising applying a second magnetic force to said belt, said second magnetic force repelling said belt in a direction substantially perpendicular to said first magnetic force.

18. The method of claim 17 and further comprising applying a third magnetic force to said belt, said third magnetic force repelling said belt in a direction substantially perpendicular to said first magnetic force and in a direction substantially opposite said second magnetic force
